(19) United States
(12) Patent Application Publication
(10) Pub. No.: US 2012/0160114 A1
(43) Pub. Date: Jun. 28, 2012

(54) METHOD TO REGISTER COLORS IN IN-TRACK DIRECTION ON A MULTICOLOR WEB PRINTING MACHINE

(76) Inventors: Volker Otto, Gettorf (DE); Karlheinz Peter, Molfsee (DE)

(21) Appl. No.: 13/311,039

(22) Filed: Dec. 5, 2011

(30) Foreign Application Priority Data
Dec. 22, 2010 (DE) 10 2010 055 852.4

(51) Int. Cl. B41M 1/14

(52) U.S. Cl. 101/211

(57) ABSTRACT

A method for printing a multi-color image on a web that is moved in a transport direction along a plurality of printing units for respectively printing one color separation of the multi-color image. A line clock is determined for the printing unit being the first one in transport direction, as a function of the transport speed of the web, and a plurality of synchronization marks is printed with the web, said synchronization marks located in a region of the web that is outside the region of the multi-color image, and printed at a prespecified clock that is formed of a partial set of the line clock. The synchronization marks are detected at a position between the first and the second printing units, and a line clock for the second printing unit in the direction of movement is determined based on the detection of the synchronization marks.

### FIELD OF THE INVENTION

The present invention relates to a method for printing a multi-color image on a printing material web, said web is moved in a transport direction along a plurality of printing units for respectively printing one color separation of the multi-color image. The method relates, in particular, to a method that ensures a registration of the different color separations in the direction of movement of the printing material web.

### BACKGROUND OF THE INVENTION

In printing technology, the most diverse methods for printing material webs are known. It is, in particular, known to print a printing material web with a plurality of ink jet print heads that are sequentially arranged in the direction of movement of the printing material web, said ink jet print heads are referred to as printing units hereinafter. In order to produce a multi-color image, color separations of the multi-color image are printed at the respective printing units. In order to prevent the inks of the respective color separations from bleeding into each other, it is known to at least partially dry the applied ink between the printing units. This drying can be provided between each of the printing units or only between selected printing units. In particular, it is known that drying does not take place between a first and a second printing unit, when the printing material web takes up sufficient ink from the first printing unit so as to avoid an undesirable inter-ink bleeding of the first two color separations. Consequently, the printing material web displays greatly varying moisture values across the printing process in a manner of being able to result in locally varying elongations of the printing material web. This can, however, cause the respective color separations of a multi-color print to be printed out of register in longitudinal direction.

### SUMMARY OF THE INVENTION

Therefore, the object to be achieved in accordance with the present invention is to provide a method for printing a multi-color image that overcomes at least one of the aforementioned problems.

In particular, a method is provided for printing a multi-color image on a printing material web that is moved in a transport direction past a plurality of printing units so as to print respective color separations of the multi-color image. With the method, a line clock is generated for the printing unit that is first in transport direction is as a function of a transport speed of the printing material web. Furthermore, a plurality of synchronization marks is printed with the printing unit that is first in the direction of movement of the printing material web, said synchronization marks is printed in a region of the printing material web that is located outside the region of the multi-color image, namely in a prespecified clock that is derived from a subset of the line clock. Subsequently, the synchronization marks are detected in a position along the direction of movement of the printing material web, said position is located between the first and the second printing units, and a line clock for the printing unit that is the second in the direction of movement is generated based on the detection of the synchronization marks.

Such a method enables a dynamic adaptation of the line clock of a second printing unit that, regardless of any elongations of the printing material web, enables the registered printing of the color separations.

Preferably, the synchronization marks are detected between each two successive printing units, and a line clock is generated for the rear one of the two printing units based on the detection of the synchronization marks. Due to this, the synchronization marks can be used for any number of subsequent printing units to generate corresponding line clocks for the respective printing unit. This, in turn, enables the corresponding line cycling of subsequent printing units, regardless of any elongations of the printing material web or any speed changes of said printing material web or both.

Preferably, the synchronization marks are continuously printed in a preset clock so as to provide a continuous line clock for the respective subsequent printing units when appropriately detected.

In accordance with an embodiment of the invention, the line clock for the second/following printing unit is interpolated between the detection of successive synchronization marks in order to achieve a desired resolution in transport direction. Therefore, the synchronization marks need not be printed with the desired resolution of the multi-color image, said resolution is determined by the line clock of the printing units and the web speed. Rather, the synchronization marks can each be separated by one or more line cycles, and the missing line cycles can be extrapolated between successive synchronization marks.

For a particularly precise registration of the color separations, the position of the detection of the synchronization marks is preferably substantially closer to the second printing unit than to the first printing unit. As a result of this, it is possible to prevent an additional length change from occurring between the detecting position and the subsequent printing unit. Preferably, the detection of the synchronization marks is directly used as the trigger for the line clock, thus resulting in a particularly simple generation of the line clock and a direct correlation between the detection and the line clock.

Preferably, an error detection is provided that recognizes when a synchronization mark was not detected and appropriately adapts the line clock for the second/following printing unit. For various reasons, it is possible that one or more synchronization marks are not detected. This would lead to an unnecessary extension of the line clock, which, in turn, would lead to an erroneous registration of the color separations. Therefore, an appropriate error detection is provided that recognizes that a synchronization mark was not detected within the prespecified reference parameters. This can be achieved, for example, in that the error detection recognizes that a distance that is essentially double the expected distance occurs between two synchronization marks, this, as a rule, is due to an erroneous detection. Accordingly, an appropriate interpolation for insertion of the corresponding required timing cycles can then be provided between these two synchronization marks. This applies, analogously, when two successive synchronization marks have not been detected.

In accordance with a preferred embodiment, the first printing unit additionally prints image start marks that can be distinguished from the synchronization marks, said the image start marks is detected between the first and the second/following printing unit(s) so as to signal an image start. As a result of this, an accumulation of errors within the line clock is prevented because each image start is determined separately by the line cycles that have been prespecified by the synchronization marks.

In one embodiment, the image start marks are different regarding their length in the direction of movement of the printing material web from the synchronization marks, and the image start marks and the synchronization marks are detected by the same detector. This results in a particularly simple design of the detector arrangement. In an alternative embodiment, the image start marks are different regarding their length transversely to the direction of movement of the printing material web from the synchronization marks, and the image start marks and the synchronization marks are detected by different detectors. It is true that this makes for a more expensive detector arrangement, however, a more reliable detection of the synchronization marks and the image start marks can be achieved because the synchronization marks are uniform. Preferably, the respective image start marks act, at the same time, as synchronization marks.

### BRIEF DESCRIPTION OF THE DRAWINGS

FIG. 1 is a schematic side view of a printing machine for printing material webs.

FIG. 2 is a schematic top view of a simplified web path with a block circuit diagram for the activation of the printing units.

### DETAILED DESCRIPTION OF THE INVENTION

Information regarding locations and directions used in the description hereinafter relate primarily to the representations in the drawings and should thus not be seen limiting. However, they can also relate to a preferred final arrangement.

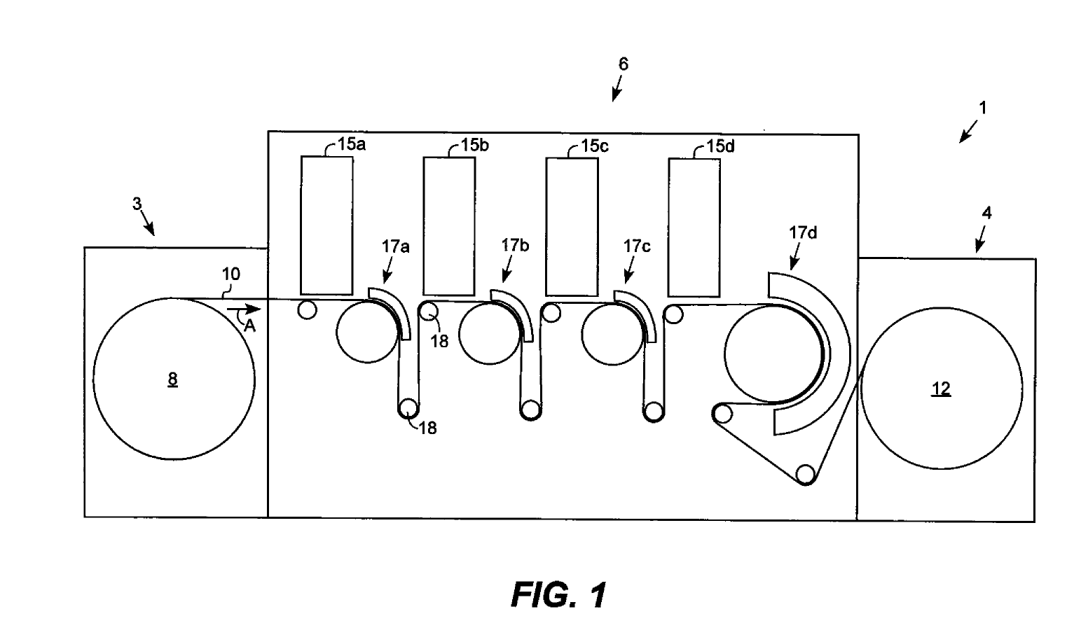

FIG. 1 is a schematic side view of a printing machine 1. The printing machine 1 includes a feeder 3, a delivery unit 4, as well as an interposed printing region 6. A printing material roll 8 is rotatable supported in the feeder 3, from where a printing material web 20 is guided through the printing region 6 to a printing material take-up roll 12 in the delivery unit 4. During a printing operation, the printing material web 10 is conveyed via a plurality of guide and transport rollers 18 in the printing region 6 from the roll 8 to the roll 12. In order to simplify the illustration, only a few guide and transport rollers 18 are shown in FIG. 1, thus greatly simplifying the illustration of the path of movement of the printing material web 10.

In the illustration of FIG. 1, the printing material web 10 is moved from left to right through the printing region 6 during a printing operation, as is indicated by arrow A.

The printing region 6 includes a plurality of printing units, 15a-d, a plurality of drying devices 17a-d, as well as a plurality of guide and transport rollers 18. FIG. 1 provides for four printing units 15a-d, so that the printing machine 1 in accordance with FIG. 1 would be suitable for four-color printing. Depending on use, however, it is also possible to provide a number of printing units that is different therefrom. In a preferred embodiment of the invention, the printing units 15a-d are ink jet printing units; however, it is also possible to use another type of printing unit that applies a medium that is liquid during application.

One of the drying devices 17a-d is provided between each of the printing units 15a-d as well as after the last printing unit 15d in transport direction. The drying unit 17d provided after the last printing unit 15d can be dimensioned larger, as needed, because this provides a final drying and the upstream drying devices 17a-c might provide only intermediate drying. Depending on use, it is possible to omit the first drying device 17a that is located viewed in transport direction of the printing material between the first and the second printing units 15a-b or to provide drying units for intermediate drying that are different from the drying units for final drying or both. The drying devices 17a-d can be of any suitable type such as, for example, microwave dryers, IR dryers, air dryers, etc.

Due to the multiple applications of a moist printing medium alternated with at least partial drying of the medium, the length of the printing material web changes locally, which without special measures can lead to registration errors in moving direction.

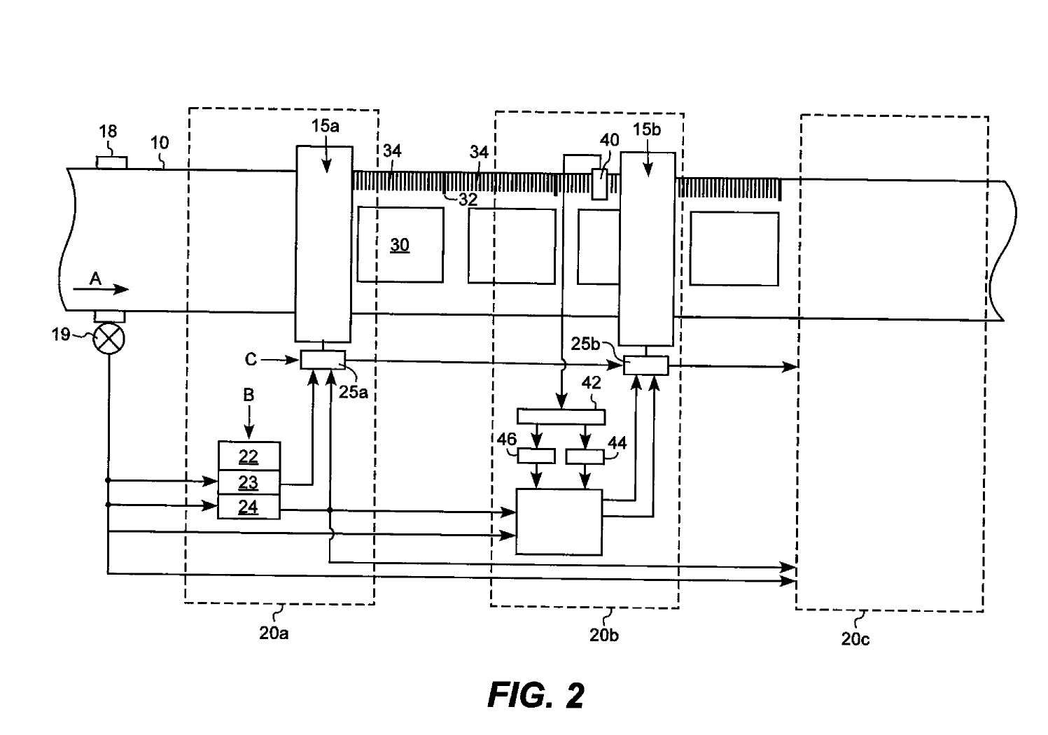

FIG. 2 is a schematic plan view of a simplified web path with a block circuit diagram for the activation of printing units. In the view in accordance with FIG. 2, the web path of the printing material web 10 is shown flat, and viewed in the direction of movement A of the printing material web 10. Only the first printing unit 15a and the second printing unit 15b are shown more specifically. The drying devices have been omitted altogether.

In the illustration in accordance with FIG. 2, the printing material web is shown flat, as has been mentioned. Only on the left end of the printing material web a transport or guide roller 18 or a transport and guide roller 18 is schematically indicated, said roller is connected with an encoder 19 in order to output a speed signal for the moving speed of the printing material web 10, as has been known from prior art. Furthermore, boxes indicated in dashed lines indicate printing modules 20a, 20b and 20c. Each of the printing modules contains a corresponding printing unit 15, however, only the printing units 15a and 15b for the printing modules 20a and 20b are shown to simplify the drawing. In addition, each of the printing modules 20 contains appropriate actuation electronics that are partially shown in block diagram form.

A timing unit 22 is provided inside the printing module 20a, said timing unit receiving image parameter data as the input signal via arrow B. The image parameter data can be, for example, the desired resolution of the images and the distances between the leading edges of the images or the corresponding frames in which the images are printed. Furthermore, the timing unit 22 receives the speed signal from the encoder 19. In a first sub-unit 23, the control unit 22 processes the encoder signals and the image parameter data (for example, the distance data between images/frames) for the output of image start clock data. The sub-unit 23 thus outputs an image start clock and can thus be referred to as the image start clock generator.

In a second sub-unit 24, the control unit 22 processes the encoder signals and the image parameter data (for example, the desired resolution) so as to generate and output line clock data. The sub-unit 24 can thus be referred to as a line clock generator. As a function of the web moving speed, the line clock determines the respective line width in the direction of movement of the printing material web 10 and thus the resolution in this direction. The prespecified resolution and the web speed can be used by the sub-unit 24 to determine and output the required line clock.

The line clock and the image start clock are transmitted to a control unit 25 that receives the actual image data as additional input data via arrow C. The control unit 25 then converts the received image data, taking into consideration the image start clock and the line clock, and activates the printing unit 15a in order to print a color separation of an image to be produced. Corresponding printing takes place within a frame or an image frame 30, said frame, as a rule, representing the dimensions of a multi-color image that is to be produced. Such image frames 30 are shown.

In addition to the actual color separation, the printing unit 15a is activated in such a manner that said printing unit prints image start marks 32, as well as synchronization marks 34, in a margin outside the image frame 30. The image start marks 32 are printed to match the image start clock, and they have a prespecified length in the direction of movement as well as in the direction transverse thereto. Taking into consideration the previously determined line clock, the synchronization marks 34 are printed, however, not every line clock is used for printing but only a partial set thereof. For example, the synchronization marks have a width (or length in the direction of movement) corresponding to a prespecified number of lines such as, for example 2, and have, in between, a prespecified distance of 8 lines, for example. Consequently the distance between the start of a synchronization mark 34 and the start of an adjacent synchronization mark would be ten lines. This means, printing of a synchronization mark 34 is begun every tenth line clock. The image start marks 32 and the synchronization marks 34 are of different types and can be different, for example, regarding their width (length in the direction of movement) or regarding their length in a direction transverse to the movement A of the printing material web 10.

As previously mentioned, the printing module 20b contains the printing unit 15b that is activated via a control unit 25b. The control unit 25b also receives the image data that, in this representation, are forwarded via the control unit 25a.

Furthermore, a detector unit 40 is provided inside the control module 20b, said detector unit detecting the occurrence of the image start marks 32, as well as of the synchronization marks 34, and outputting a corresponding detecting signal to a processing unit 42. The output signal of the detector unit 40 is such that the processing unit 42 can differentiate between the detection of the image start marks 32 and that of the synchronization marks 34. The detector unit 40 can comprise a single detector that, for example, emits a simple pulse signal at light/dark transitions. In such an arrangement, the image start marks 32 and the synchronization marks would be different, for example, as to their width (length in moving direction of the printing material web 10). However, the detector unit 40 can also comprise two such detectors, one of said detectors is directed at a region outside the track of the synchronization marks 34, but inside the track of the image start marks 32, in order to recognize corresponding pulses when an image start mark 32 is passing through.

The detector unit 40 should be arranged as closely as possible near the respective subsequent printing unit in order to be able to predict, as well as possible, the local length state of the printing material web 10 inside the subsequent printing unit 15. The farther the detector unit 40 is from the subsequent printing unit 15, the greater is the possibility that the state of the printing material web 10 between the point of detection and the printing unit 15 will change. The minimal distance between the detector unit 40 and the subsequent printing unit 15 is conditioned by the (maximum) web moving speed, the time for generating and, optionally, verifying and correcting a line clock (as will be described in greater detail hereinafter) and the time required for the application of ink to the printing material web 10 after a corresponding actuation of the printing unit 15.

The pulse signals of the detector 40 can be processed by the processing unit 42 in an appropriate manner. The processing unit 42 can output a first signal, consistent with the detection of the image start marks 32, to an image start clock generator 44 that, subsequently, outputs an image start clock signal. In addition, the processing unit 42 can output a second signal, consistent with the detection of the synchronization marks 34, to the line clock generator 46. Based on the signals of the processing unit 42, a line clock for the printing unit 15b is generated within the line clock generator 46. The line clock generator 46 knows that the time period between the detections of sequential synchronization marks 34 has to be filled with a prespecified number of line cycles in the example hereinabove, with ten line cycles. These are uniformly distributed over the time period between the detections of two successive synchronization marks 34.

The line clock signals and the image start signals generated this way are transmitted to a timing and verification unit 48 that receives, as additional inputs, the web speed from the encoder 19 and the line clock data of the line clock generator of the first printing module 20a. With the use of these data, the unit 48 can verify whether the line clock data and the image start clock data are plausible. If this is the case, said unit forwards the corresponding clock data unchanged to the control unit 25b. If this is not the case, the unit can optionally correct the clock data.

For example, such correction can be necessary when the detector 40 erroneously does not detect a synchronization mark 34 which would have the result that the line clock generated by the line clock generator 46 suddenly displays double the distance between successive cycles. If this does not correlate with the line clock data of the first printing module 20a and the web speed data by the encoder 19, the unit 48 performs an appropriate correction and fills the intermediate spaces with the corresponding line cycles and outputs these to the control unit 25b. Then, the printing unit 15b is actuated in the corresponding manner with the so generated image start clock data and the line clock data in order to print a corresponding color separation within the image frame 30. The printing module 20c is constructed in the same manner as the printing module 20b, and this also applies to any additional printing modules, not shown. From the description hereinabove, it becomes clear that, with the exception of the first printing module 20a, a line clock based on the detection of the synchronization marks 34 takes place in all subsequent printing modules. Accordingly, the image start cycles are also generated on the basis of the detection of the image start marks 32. As a result of this, local elongations of the printing material web, for example caused by a moisture or fluid carry-over, are detected and taken into consideration for the line clock data generation. This enables the registered printing of several color separations in the direction of movement A of the printing material web 10.

The invention has been described with reference to a preferred embodiment of the invention, without being restricted to the specifically shown embodiment. Additional modifications and changes can be inferred by persons skilled in the art within the framework of their expert knowledge.

The invention has been described in detail with particular reference to certain preferred embodiments thereof, but it will be understood that variations and modifications can be effected within the spirit and scope of the invention.

1. Method for printing a multi-color image on a printing material web, said web is moved in a transport direction along a plurality of printing units for respectively printing one color separation of the multi-color image, said method comprising the following steps:
generating a line clock for the printing unit being the first one in transport direction of the printing material web, as a function of a transport speed of the printing material web;
printing a plurality of synchronization marks with the printing unit that is the first in the direction of movement of the printing material web, said synchronization marks are located in a region of the printing material web outside the region of the multi-color image, and are printed in a prespecified clock that is derived from a partial set of the line clock;
detecting the synchronization marks in a position along the direction of movement of the printing material web, said position is located between the first and the second printing units; and
generating a line clock for the printing unit being the second one in the direction of movement of the printing material web, based on the detection of the synchronization marks.

2. Method as in claim 1, wherein the synchronization marks are respectively detected between two successive printing units, and a line clock is generated for the rear one of the two printing units based on the detection of the synchronization marks.

3. Method as in claim 1, wherein the synchronization marks are continuously printed in a prespecified clock.

4. Method as in claim 1, wherein the line clock for the second printing unit is interpolated between the detection of successive synchronization marks in order to achieve a desired resolution in transport direction.

5. Method as in claim 1, wherein the position of the detection of the synchronization marks is substantially closer to the second printing unit than to the first printing unit.

6. Method as in Clam 1, wherein the detection of the synchronization marks is directly used as the trigger for the line clock.

7. Method as in claim 1, wherein an error detection is provided, said error detection recognizing when a synchronization mark was not detected and appropriately adapting the line clock for the second/following printing unit.

8. Method as in claim 1, wherein the first printing unit additionally prints image start marks that can be distinguished from the synchronization marks, and wherein the image start marks are detected between the first and the second/following printing unit(s) so as to signal an image start.

9. Method as in claim 8, wherein the image start marks are different regarding their length in the direction of movement of the printing material web from the synchronization marks, and the image start marks and the synchronization marks are detected by the same detector.

10. Method as in claim 8, wherein the image start marks are different regarding their length transversely to the direction of movement of the printing material web from the synchronization marks, and the image start marks and the synchronization marks are detected by different detectors.

11. Method as in claim 8, wherein the image start marks act, at the same time, as synchronization marks.

12. Method as in claim 1, wherein the respective printing units apply ink to the printing material web for the printing of color separations.
